(19) United States
(12) Patent Application Publication
(10) Pub. No.: US 2009/0193896 A1
(43) Pub. Date: Aug. 6, 2009

(54) TURBOCHARGER ROTATIONAL SPEED SENSOR

(76) Inventors: Lawrence M Rose, Berkley, MI (US); August Thomas Vaught, Harper Woods, MI (US)

Correspondence Address: RICHARD M. SHARKANSKY, PO BOX 557, MASHPEE, MA, 02649, US

(21) Appl. No.: 12/023,749

(22) Filed: Jan. 31, 2008

(51) Int. Cl. G01H 17/00; F02D 23/00

(52) U.S. Cl. 73/584; 60/602

(57) ABSTRACT

An internal combustion engine system having a turbocharger having compressor driven by a turbine through a common shaft is disclosed. An acoustic sensor is displaced from the compressor and positioned relative to the compressor to detect sound waves emitted by the compressor during rotation of the compressor about the common shaft by the turbine and for producing an electrical signal in response to such detected sound waves. A processor is responsive to the produced electrical signal for controlling operation of the engine system during operation of such engine system.

### TECHNICAL FIELD

This invention relates generally to turbochargers and more particularly to turbocharger rotational speed sensors.

### BACKGROUND

As is known in the art, a turbocharger for use with an automotive engine generally includes a compressor rotor mounted on one end of a driveshaft and a turbine rotor mounted on the shaft at the opposite end. The air enters the compressor from the air filter box is compressed, and passed through the intake manifold of the engine. The exhaust gas produced by the engine has substantially greater energy than the inducted air. The turbine extracts the energy of the exhaust gas to drive the compressor, which boosts the pressure of the air before it is inducted by the engine. In this way, a turbocharged engine delivers a greater mass of air to the engine than a naturally aspirated system. This allows more fuel to be burned and, thus, more power can be produced by the engine.

As is also known in the art, it is frequently desirable to know the rotational speed of the compressor. Current sensors are however relatively expensive, and require modification of the turbocharger assembly.

### SUMMARY

In accordance with the present invention, an internal combustion engine system comprises: a turbocharger having a compressor driven by a turbine through a common shaft; an acoustic sensor displaced from the compressor and positioned relative to the compressor to detect sound waves emitted by the compressor during rotation of the compressor about the common shaft by the turbine and for producing an electrical signal in response to such detected sound waves; and a processor responsive to the produced electrical signal for controlling operation of the engine system during operation of such engine system.

The sound produced by a turbocharger is a function of the turbocharger geometry and rotational speed. By having prior knowledge of a turbocharger's geometry, and sensing the acoustic signature of the turbocharger when operating, the turbocharger's rotational speed can be determined. The use of an acoustic sensor to capture the turbocharger's sound and a computer to process the signal produced by the sensor provides a relatively inexpensive rotational speed sensor.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatical sketch of an internal combustion engine system having a turbocharger rotational speed senor according to the invention; and

FIG. 2 is an enlarged portion of the internal combustion engine of FIG. 1, such portion being encircled by arrow 2-2 in FIG. 1, such portion showing the mounting of a microphone on an inner wall of an inlet tube used in the system of FIG. 1.

Like reference symbols in the various drawings indicate like elements.

### DETAILED DESCRIPTION

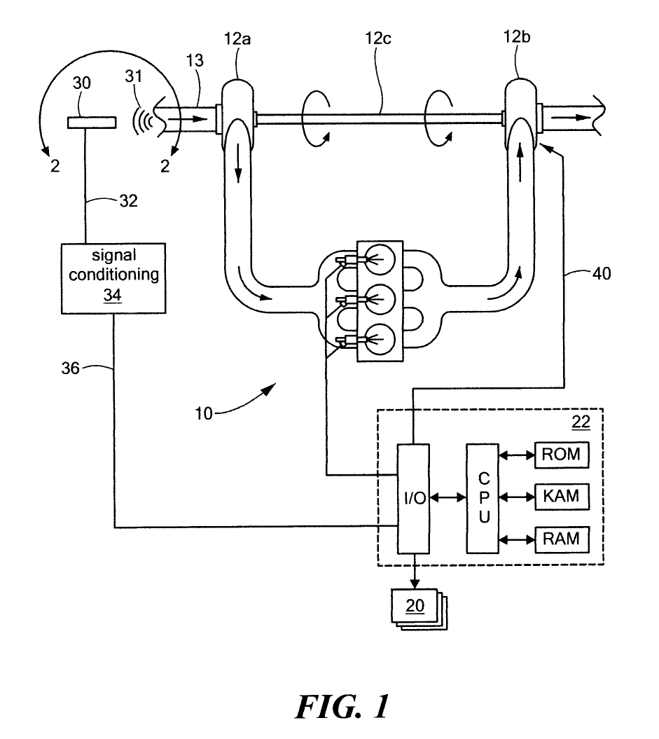

As shown in FIG. 1, an internal combustion engine system 10, which may comprise either a diesel engine or another type of internal combustion engine known to those skilled in the art and suggested by this disclosure, receives inlet air from turbocharger 12, which includes compressor section 12a, which is driven by turbine section 12b via common shaft 12c. Here the turbine section 12b is a controllable turbine via a waste gate or some other control input. The turbine section 12b are controlled by controller 22 which is drawn from the range of engine controllers known to those skilled in the art and suggested by this disclosure. Controller 22 receives information from a variety of sensors 20, including an acoustic senor 30, to be described. Conventionally, controller 22 has inter alia, a read-only-memory (ROM), a keep-alive-memory (KAM), a readable-addressable-memory (RAM), and a central processor (CPU). The CPU controls engine parameters including at least one of: throttle angle, EGR valve opening, spark timing, injection timing, injection pressure, fuel quantity delivered, and urea delivered.

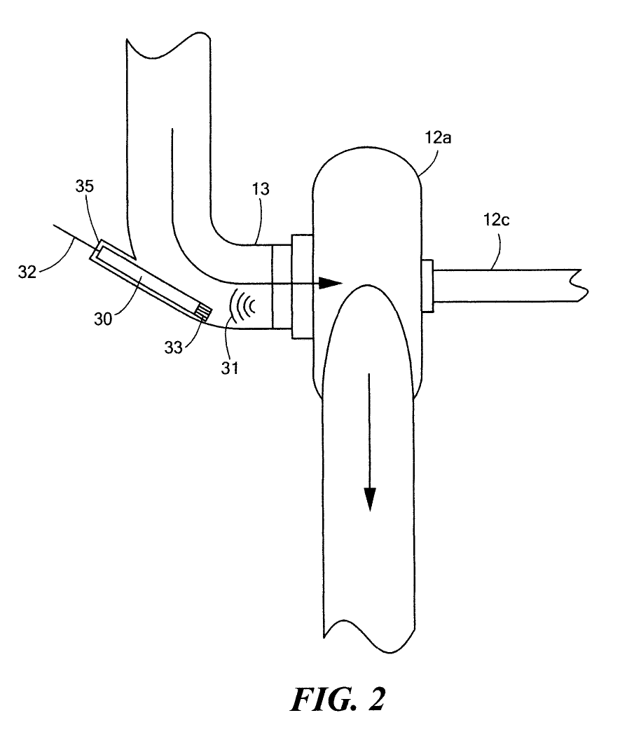

An acoustic sensor 30 is mechanically mounted in a pocket 35 formed on an inner wall of the inlet 13 as shown in FIG. 2, with the active acoustic wave detection sensor portion 33 pointed downstream of the airflow through the inlet spaced from the compressor section 12a yet positioned relative to the compressor 12a to detect sound waves 31 emitted by the compressor 12a during rotation of the compressor 12a about the common shaft 12c by the turbine 12b. The electrical signals produced by the acoustic sensor 30 on line 32 are fed to a signal conditioner 32, the output of which represents the rotational speed of the compressor section 12a. The acoustic sensor 30 may be, for example, a microphone or a piezoelectric transducer. The sensor 30 is here mechanically mounted to compressor inlet tube 13 as described above such that it responds to sound waves emitted by the compressor 12a and is isolated from detecting mechanical vibrations of the compressor 12a. It is to be noted that here the engine is in a motor vehicle, such as a bus, truck, car, boat, and that the microphone is also disposed in the vehicle.

The signals on line 32 are fed to a signal conditionings circuit 34, here, for example, a zero crossings detector and counter/timer to detect the frequency of the dominant sound frequency component of the signals on line 32 or may includes an FFT processor to detect such sound component.

The controller 22 is responsive to electrical signal on line 36 from the signal conditioning circuit 34, for controlling operation of the engine system 10 during operation of such engine system 10 including controlling the speed of the turbine section 12b via the control signal; on line 40.

A number of embodiments of the invention have been described. Nevertheless, it will be understood that various modifications may be made without departing from the spirit and scope of the invention. Accordingly, other embodiments are within the scope of the following claims.

What is claimed is:

1. An internal combustion engine system, comprising:
a turbocharger having a compressor driven by a turbine through a common shaft;
an acoustic sensor displaced from the compressor and positioned relative to the compressor to detect sound waves emitted by the compressor during rotation of the compressor about the common shaft and for producing an electrical signal in response to such detected sound waves; and
a processor responsive to the produced electrical signal for controlling operation of the engine system during operation of such engine system.

2. The system recited in claim 1 wherein the acoustic sensor is mechanically mounted on an inner wall of an inlet to the compressor.

3. The system recited in claim 2 wherein the sensor has an acoustic wave detection sensor portion pointed downstream of the airflow through the inlet to the compressor.

4. The system recited in claim 2 wherein the acoustic sensor is mechanically mounted in a pocket formed on an inner wall of an inlet to the compressor.

5. The system recited in claim 4 wherein the sensor has an active acoustic wave detection sensor portion pointed downstream of the airflow through the inlet to the compressor

6. An internal combustion engine system having a turbine coupled to an engine exhaust and a compressor coupled to an engine intake, said turbine and compressor coupled through a common shaft, comprising:
an acoustic sensor for detecting sound waves emitted by the compressor, such acoustic sensor located near the compressor; and
a processor electrically coupled to said acoustic sensor, said processor determining the rotational speed of the compressor based on said acoustic sensor signal.

7. The system recited in claim 6 wherein the acoustic sensor is mechanically mounted on an inner wall of an inlet to the compressor.

8. The system recited in claim 7 wherein the sensor has an acoustic wave detection sensor portion pointed downstream of the airflow through the inlet to the compressor.

9. The system recited in claim 7 wherein the acoustic sensor is mechanically mounted in a pocket formed on an inner wall of an inlet to the compressor.

10. The system recited in claim 9 wherein the sensor has an acoustic wave detection sensor portion pointed downstream of the airflow through the inlet to the compressor.

11. A method for controlling an internal combustion engine with an inlet compressor coupled to the engine, comprising:
providing an acoustic sensor for detecting sound waves emitted by the compressor, such acoustic sensor located near the compressor;
providing an electronic control unit coupled to the engine and said acoustic sensor; and
controlling an engine parameter based on a signal from said acoustic sensor.

12. The method recited in claim 11 wherein said engine parameter is at least one of: throttle angle, EGR valve opening, spark timing, injection timing, injection pressure, fuel quantity delivered, and urea delivered.

13. The method recited in claim 11, further comprising: mounting said sensor on an inner wall of an inlet to the compressor.

14. The method recited in claim 13 wherein the sensor has an acoustic wave detection sensor portion pointed downstream of the airflow through the inlet to the compressor.

15. The method recited in claim 14 wherein the acoustic sensor is mechanically mounted in a pocket formed on an inner wall of an inlet to the compressor.
